(19) United States
(12) Patent Application Publication
(10) Pub. No.: US 2022/0373357 A1
(43) Pub. Date: Nov. 24, 2022

(54) METHOD AND DEVICE FOR ASSISTING IN LANDING AN AIRCRAFT UNDER POOR VISIBILITY CONDITIONS

(71) Applicant: THALES, COURBEVOIE (FR)

(72) Inventors: Thierry GANILLE, Mérignac (FR); Jean-Emmanuel HAUGEARD, Gennevilliers (FR); Pierre-Yves DUMAS, Mérignac (FR)

(21) Appl. No.: 17/775,225

(22) PCT Filed: Nov. 3, 2020
(86) PCT No.: PCT/EP2020/080807

§ 371 Date: May 6, 2022

(30) Foreign Application Priority Data
Nov. 7, 2019 (FR) FR1912486

(51) Int. Cl. G01C 23/00; G06V 20/17; G06V 10/82; G06T 7/70; G08G 5/02; B64D 43/00; B64D 45/08; G01S 13/934; G01S 13/86; G01S 13/89; G01S 17/89; G01S 17/86; G01S 17/933

(52) U.S. Cl. CPC G01C 23/005; G06V 20/17; G06V 10/82; G06T 7/70; G08G 5/025; B64D 43/00; B64D 45/08; G01S 13/934; G01S 13/867; G01S 13/89; G01S 17/89; G01S 17/86; G01S 17/933; G06T 2207/10044; G06T 2207/20084; G06T 2207/20081

(57) ABSTRACT

Method and device for assisting with landing an aircraft under poor visibility conditions are provided. The method allows sensor data to be received during a phase of approach toward a runway when the runway and/or an approach lighting system are not visible to the pilot from the cockpit; then, in the received sensor data, data of interest characteristic of the runway and/or the approach lighting system to be determined; then, on the basis of the data of interest, the coordinates of a target area to be computed; and, on a head-up display, a guiding symbol representative of the target area to be displayed, the guiding symbol being displayed before the aircraft reaches the decision height, in order to provide the pilot with a visual cue in which to search for the runway and/or approach lighting system.

The invention relates to the field of systems for assisting with landing aircraft, based on on-board cameras or imaging sensors.

The invention more precisely addresses the problem of assisting aircraft with landing under difficult meteorological conditions, and in particular under conditions in which visibility is low or poor, as when foggy for example.

Aviation standards set rules in respect of the visibility that must be obtained when landing. These rules are reflected in decision thresholds that refer to the altitude of the airplane during the descent phase thereof. By regulation, an aircraft pilot operating under instrument flight rules (IFR) must, when landing, visually acquire certain references composed of elements of the approach lighting system (ALS) or of the runway, and do so before an altitude or a height determined for each approach. Thus, reference is made to decision altitude (DA) and decision height (DH), this altitude and height varying depending on the category of any runway equipment (CAT I or CAT II or CAT III ILS), on the type of approach (precision, non-precision, ILS, LPV, MLS, GLS, etc.) and on the topographical environment around the runway (level ground, mountainous, obstacles, etc.). Typically, at an airport equipped with a CAT I ILS on level ground, the commonest case at the present time, a decision height (DH) is 60.96 meters (200 ft) and a decision altitude (DA) is +60.96 meters (+200 ft) from the altitude of the runway.

During landings under poor visibility conditions (for example because of fog, snow, rain), it is more difficult to acquire visual references at each of the thresholds. If the pilot has not visually acquired the regulatory references before reaching the DA or DH, he must abort the landing (missed approach flown to regain altitude) and either retry the same approach, or divert to a diversion airport. Missed approaches are costly to airlines, and aborted landings are really problematic to air-traffic management and flight planning. It is necessary to estimate, before take-off, whether it will be possible to land at the destination on the basis of relatively unreliable weather forecasts, and if necessary provide fallback solutions.

Thus the problem of landing aircraft under poor visibility conditions has led to the development of a number of techniques.

One of these techniques is ILS (acronym of instrument landing system). ILS requires a plurality of radiofrequency devices to be installed on the ground, near the runway, and a compatible instrument to be located on-board the aircraft. Such a guiding system requires expensive devices to be installed and pilots to undergo specific training. Moreover, it cannot be installed at all airports. This system is employed at major airports only, because its cost prohibits its installation at others. Furthermore, new technologies based on satellite positioning systems will probably replace ILS in the future.

A solution called SVS (acronym of synthetic vision system) allows terrain and runways to be displayed, based on the position of the aircraft as provided by GPS and its attitude as provided by its inertial measurement unit. However, the uncertainty in the position of the aircraft and the accuracy of runway-position databases prohibit the use of SVS in critical phases when the aircraft is close to the ground, such as landing and take-off. More recently, SVGS (acronym of synthetic vision guidance system) has added certain enhancements to SVS, allowing a limited decrease in landing decision thresholds (DH decreased by 15.24 meters (50 ft) on SA CAT I ILS approaches only).

Another solution, known as EVS or EFVS (acronym of enhanced (flight) vision system), which is based on display on a head-up display, allows an image of the forward environment of the aircraft that is an improvement over what is visible to the naked eye to be displayed on the primary display of the pilot. This solution uses electro-optical, infrared or radar sensors to film the airport environment while an aircraft is being landed. The principle is to use sensors that perform better than the naked eye of the pilot under poor meteorological conditions, and to embed the information collected by the sensors in the field of view of the pilot, by way of a head-up display or on the visor of a helmet worn by the pilot. This technique is essentially based on the use of sensors to detect the radiation emitted by lights positioned along the runway, and by the lights of the approach lighting system. Incandescent lamps produce visible light, but they also emit in the infrared. Infrared sensors allow this radiation to be detected, and their detection range is better than that of the naked human eye in the visible domain under poor meteorological conditions. Improving visibility therefore to a certain extent allows approach phases to be improved and missed approaches to be limited. However, this technique is based on the undesired infrared radiation emitted by lights present near the runway. To increase light durability, the current trend is to replace incandescent lights with LED lights. The latter have a narrower spectrum in the infrared range. One upshot is to make EVS systems based on infrared sensors obsolete.

One alternative to infrared sensors is to obtain images using a radar sensor, in the centimeter- or millimeter-wave band. Certain frequency bands chosen to lie outside of the absorption peaks of water vapor have a very low sensitivity to difficult meteorological conditions. Such sensors therefore make it possible to produce an image through fog for example. However, even though these sensors have a fine distance resolution, they have an angular resolution that is far coarser than optical solutions. Resolution is directly related to the size of the antennas used, and it is often too coarse to allow the position of the runway to be accurately determined at a distance large enough to allow realignment maneuvers to be performed.

The adoption of active sensors, such as LIDAR (acronym of light detection and ranging) or millimeter-wave radars, which are capable of detecting the runway from further away and under almost any visibility conditions, has led to much better results than achieved with passive sensors such as IR cameras. However, the data generated by such sensors do not allow the pilot to be provided with an image that is as clear and easily interpretable as an IR image.

Solutions using CVS (acronym of combined vision system) are based on simultaneous display of all or some of a synthetic image and of a sensor image, the various images for example being superimposed, registration of the synthetic image possibly being achieved using a notable element of the sensor image, or indeed the sensor image being embedded in an inset in the synthetic image, or else notable elements or elements of interest of the sensor image being clipped and embedded in the synthetic image.

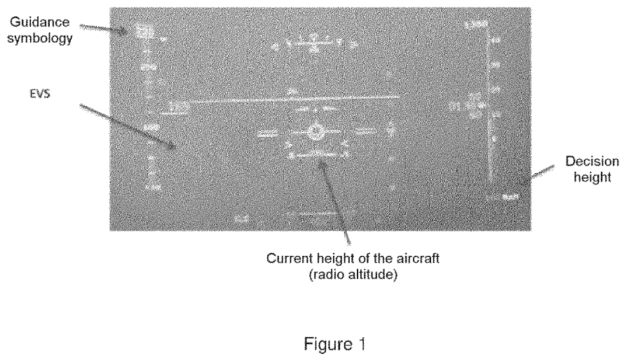

In state-of-the-art head-up EVS/EFVS systems, the pilot, before being able to see the approach lighting system or the runway, expects to see them appear in the vicinity of the velocity vector and of the synthetic runway. FIG. 1 illustrates a landing guidance symbology for a head-up display of an EVS system. The correctness of the symbols essentially depends on the accuracy of the data on the attitude of the aircraft. Although roll and pitch are generally known with a high accuracy, this is not always the case for heading, in particular in aircraft equipped with an AHRS (acronym of attitude and heading reference system, which is a set of sensors on 3 axes allowing the position of an aircraft in space to be defined by virtue of the accelerations and the magnetic fields to which they are subjected), in which the heading error may reach 2 to 3 degrees, rather than an IRS (acronym of inertial reference system), an IRS being much more precise but also much more expensive. This may result in the display of the guiding symbology being shifted by as many degrees. Now, as a result, the pilot, who will concentrate his search for visual references around the velocity vector, may then detect the runway later than he might otherwise, in particular under meteorological conditions causing poor visibility. In many situations, the decision height may be reached before visual detection of the runway is achieved, and a missed approach may be flown that could have been avoided.

Thus, there is a need to assist pilots with visual identification of runways.

One object of the invention is to mitigate the drawbacks of known techniques by meeting the aforementioned needs with a solution for assisting with landing aircraft, and especially for assisting pilots with visual identification before the decision height (DH) or decision altitude (DA) is reached.

To obtain the desired results, a computer-implemented method for assisting with landing an aircraft under poor visibility conditions is provided, the method comprising at least the steps of:
receiving during a phase of approach toward a runway data generated by a sensor, said runway and/or an approach lighting system not being visible to the pilot from the cockpit;
determining, in the received sensor data, data of interest characteristic of said runway and/or of said approach lighting system;
computing, on the basis of the data of interest, the coordinates of a target area; and
displaying, on a head-up display, a guiding symbol representative of the target area, said guiding symbol being displayed before the aircraft reaches the decision height, in order to provide the pilot with a visual cue in which to search for said runway and/or approach lighting system.

According to some alternative or combined embodiments:
the step of receiving data consists in receiving data from a sensor located on-board the aircraft and looking forward, said sensor being chosen from the group consisting of FLIR guidance sensors, a multi-spectral camera, a LIDAR or a millimeter-wave radar.
the step of determining data of interest consists in executing an artificial-intelligence algorithm on the received sensor data, the algorithm implementing an artificial-intelligence model trained for image processing, said model being obtained in a training phase by deep learning.
the deep learning is based on convolutional neural networks.
the step of computing a target area consists in determining, on the basis of the characteristics of the sensor and of the attitude of the aircraft corresponding to the sensor data, heading and elevation coordinates of the target area.
the method comprises, after the step of computing a target area, a step of sending the coordinates of the target area to the head-up display.
the coordinates of the target area correspond to two opposite corners of a rectangle framing the data of interest characteristic of said runway and/or said approach lighting system, and wherein the guiding symbol that is displayed is said framing rectangle.
the step of head-up display consists in displaying the framing symbol on a fixed head-up display of the cockpit and/or on a head-up display worn by the pilot.

The invention also covers a computer program product comprising code instructions allowing the steps of the claimed method for assisting with landing an aircraft, in particular under poor visibility conditions, to be performed, when the program is executed on a computer.

The invention in addition covers a device for assisting with landing an aircraft, especially under poor visibility conditions, the device comprising means for implementing the steps of the method for assisting with landing an aircraft under poor visibility conditions, i.e. the method as claimed in any one of the claims.

In one embodiment, the data allowing the target area to be computed are generated by a first sensor, the device in addition comprising a second sensor able to deliver an image displayable on the head-up device worn by the pilot, the guiding symbol computed on the basis of the data of the first sensor being displayed in said image delivered by the second sensor.

Another subject of the invention is a human-machine interface comprising means for displaying a guiding symbol obtained according to the claimed method.

Another subject of the invention is a system for assisting with landing, especially of SVS, SGVS, EVS, EFVS or CVS type, incorporating a device such as claimed for assisting with landing an aircraft, especially under poor visibility conditions.

The invention also relates to an aircraft comprising a device such as claimed for assisting with landing an aircraft, especially under poor visibility conditions.

Other features, details and advantages of the invention will become apparent on reading the description, which is given with reference to the appended drawings, which are given by way of example and which show, respectively:

FIG. 1 a known landing symbology for a head-up display of an EVS system;

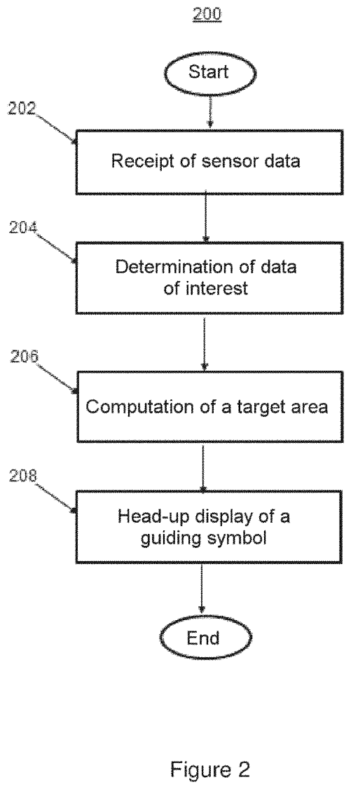

FIG. 2 a method for assisting with landing an aircraft, allowing a guiding symbol to be obtained for a head-up display, according to one embodiment of the invention;

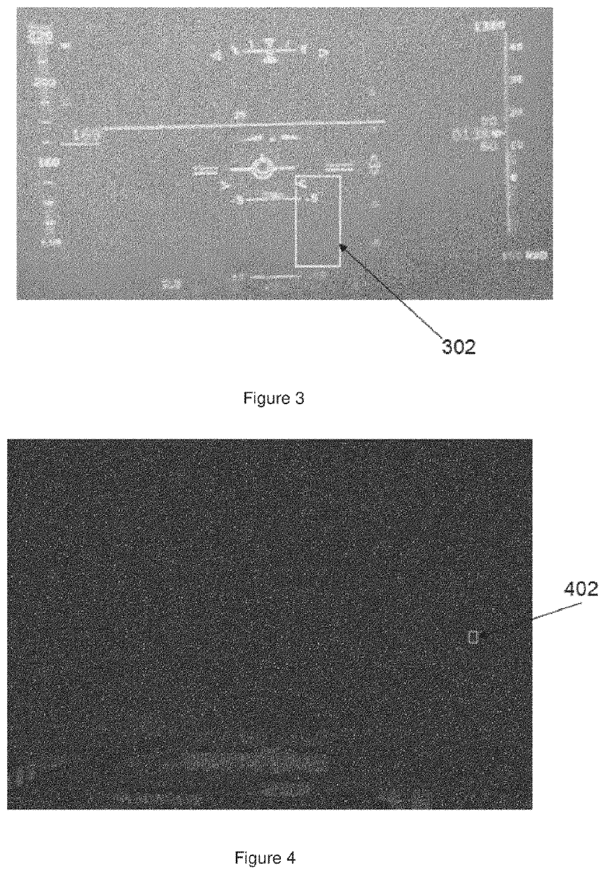

FIG. 3 a head-up display of an EVS system with a guiding symbol obtained using the method of the invention displayed;

FIG. 4 a symbol according to the invention displayed on an IR image; and

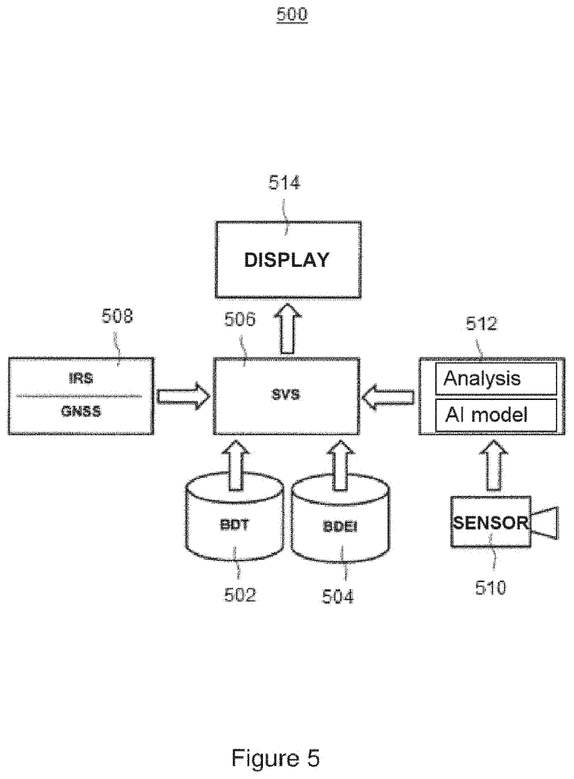

FIG. 5 a general architecture of a display system allowing the method of the invention to be implemented.

FIG. 2 illustrates the steps of a method 200 for assisting with landing an aircraft, allowing a guiding symbol to be obtained for a head-up display, according to one embodiment of the invention.

The method begins with receipt 202 of sensor data generated by a forward-looking sensor located on-board the aircraft. The method of the invention applies to any type of sensor (FLIR guidance sensor delivering an IR image, multi-spectral camera, LIDAR, millimeter-wave radar, etc.).

The technical problem that the invention solves is that of assisting with detection of the runway of an aircraft by the pilot in a sensor image or with the naked eye before the decision height is dropped below, especially under poor visibility conditions. The invention allows a new guiding symbol generated using a technique for automatically detecting the approach lighting system (ALS) or the runway in data generated by a sensor (sensor data) to be displayed. Advantageously, the displayed symbol is perfectly consistent with the outside world and indicates to the pilot the area in which the runway and/or the approach lighting system will appear, before they can be seen by the pilot with the naked eye, i.e. through direct vision. This allows the pilot to identify where to look for the expected visual references, but also to indicate to him when to look for them, especially if visibility conditions are poor, as, once the system has identified the runway and/or the lighting system and has displayed the symbol, the pilot expects to be able to identify them/it himself visually.

In a following step (204), after the sensor data have been received, the method allows data of interest that are characteristic of the runway and/or of the approach lighting system to be determined in the received sensor data. The sensor may be an IR or multispectral sensor the image of which is presented to the pilot, or be an active second sensor (which in principle is more effective than an IR sensor), such as a millimeter-wave radar for example, the data of which is not displayable to the pilot because they are difficult to interpret.

In one embodiment, the data of interest are determined by implementing a conventional algorithm for detecting patterns and straight lines. Patent application FR3 049 744 of the Applicant describes one example of such a conventional detecting algorithm. In one embodiment, the algorithm consists in computing a box encompassing detected elements of interest, said box taking the form of a rectangle the coordinates in pixels of two opposite corners of which correspond to the smallest X and Y coordinates of the pixels belonging to the detected elements, and to the largest X and Y coordinates of the pixels belonging to the detected elements, respectively. The area of the rectangle may be increased by a few percent, for example 10%, while remaining centered on the initial rectangle.

In one preferred embodiment, the step of determining data of interest consists in executing an artificial-intelligence algorithm on the received sensor data, the algorithm implementing an artificial-intelligence model trained for image processing, said model being trained to detect runways and approach lighting systems. The trained model is a model, hosted on-board the aircraft in operational use, that was obtained in a training phase, and in particular by deep learning using an artificial neural network, for detecting runways and approach lighting systems. In one advantageous embodiment, the artificial neural network is a convolutional neural network (CNN).

A conventional CNN-based model may be employed to detect and segment runways and approach lighting systems, for example using a Mask RCNN architecture (regions with CNN features)—ResNet 101 (101 layers) [Mask R-CNN—Kaiming et al. 2017]. Transfer learning (then more in-depth learning) may be employed to tailor this model to the use case of runways and approach lighting systems.

After a training phase, in which the CNN models are trained, it is important to validate the trained model via a phase of testing on data. In order to test the robustness of the model with respect to the variabilities with which it will be confronted in an operational environment (various meteorological conditions, various runways, various approach lighting systems), these data will not have been used in the training phase. A plurality of training and testing iterations may be necessary to obtain a valid and generic CNN model meeting the operational need. The validated model (i.e. its architecture and the learned hyperparameters) may be integrated into a system located on-board an aircraft comprising at least one sensor of the same type as the sensor used for training.

In the field of computer vision, the objective of deep learning is to model, with a high level of abstraction, data. In brief, there are two phases: a training phase and an inference phase. The training phase allows a trained AI model that meets the operational need to be defined and generated. This model is then used in the operational context, in the inference phase. The training phase is therefore essential. Training is considered to have succeeded if it allows a predictive model to be defined that not only fits the training data well, but that is also capable of correctly predicting data that it did not see during training. If the model does not fit the training data, the model suffers from underfitting. If the model fits the training data too well and is not capable of generalizing, the model suffers from overfitting.

In order to obtain the best model, the training phase requires a large database that is as representative of the operational context as possible to have been generated and the data of the database to have been labeled with regard to a ground truth (GT).

The ground truth is a reference image that represents an expected result of a segmenting operation. In the context of the invention, the ground truth of an image contains at least one runway and one approach lighting system, and the visible ground. The result of a segmentation of an image is compared with the reference image or ground truth, in order to evaluate the performance of the classifying algorithm.

Thus, on the basis of many labeled images, the training phase allows the architecture of the neural network and the associated hyperparameters (the number of layers, the types of layers, the training step size, etc.) to be defined, then, in successive iterations, the best parameters (the weightings of the layers and between the layers), i.e. the parameters that model the various labels (runway/approach lighting) best, to be found. In each iteration of the training, the neural network propagates (extracts/abstracts characteristics specific to the objects of interest) and estimates whether the objects are present and if so their positions. On the basis of this estimate and of the ground truth, the learning algorithm computes a prediction error and backpropagates it through the network in order to update the parameters of the model.

A training database must contain a very large number of data representing a maximum of possible situations, encompassing, in the context of the invention, various approaches to various runways with various approach lighting systems for various meteorological conditions. In order to implement a deep-learning method and to learn to recognize a runway in the received sensor data, the database that is constructed contains a plurality of labeled or tagged datasets, each labeled dataset corresponding to one (sensor datum/ground truth) pair. In the operational context of the present invention, a ground truth is a description of various elements of interest that have to be recognized in the sensor data, including at least one runway and one approach lighting system.

Returning to FIG. 2, after the step of determining data of interest in the received sensor data, the method allows an area in which the approach lighting system and/or the runway have been detected to be computed.

In one embodiment, the computed target area is a rectangle framing the identified elements of interest. On the basis of the characteristics of the sensor and of the attitude of the aircraft corresponding to the sensor data, the method allows the heading and elevation coordinates of two opposite corners of a framing rectangle to be computed.

After the target area has been computed, the coordinates are sent to a head-up display (or head-down display in a head-down EVS or CVS device), which may or may not be worn, and the area is displayed in a following step (208) as a guiding symbol that is consistent with the outside world, and that takes the form of a framing rectangle. FIG. 3 illustrates a head-up display of an EVS system with a guiding symbol (302) obtained using the method of the invention displayed.

The display of the symbol allows the path to the runway to be validated before visual acquisition of the latter by the pilot. The display of the symbol thus assists the pilot with acquisition of the mandatory visual references before the DH, since he knows that he must look inside the rectangle.

In one embodiment, the head-up device may also display an SVS, EVS, or CVS view. In the last two cases (EVS or CVS), the sensor image displayed is the one that fed to the AI search.

In another embodiment, such as illustrated in FIG. 4, the method allows head-up display of an IR image in which the pilot is able to search for the required visual references with the assistance of a framing symbol (402), a rectangle for example, generated following detection of the runway, by the CNN model or by any other runway- and ALS-detecting algorithm, in data from an active sensor, a millimeter-wave radar for example. This embodiment is particularly advantageous because active sensors have enhanced detection capabilities with respect to IR sensors under poor visibility conditions; however, the data delivered by these sensors are not easily interpretable with the human eye. In this variant of embodiment, the aircraft benefits from the EFVS decrease in landing minima.

In another embodiment, the on-board sensor is a simple visible camera and its image is not presented to the pilot. Only the guiding symbol generated via the method of the invention is presented to the pilot, this symbol assisting him with visual detection of the runway, for example during VFR flights with reduced visibility (VFR being the acronym of view flight rules). This embodiment does not benefit from any decrease in landing minima.

FIG. 5 illustrates a general architecture of a display system 500 allowing the method of the invention to be implemented.

In one preferred implementation, an AI model that has been validated (architecture and the learned hyperparameters validated) is integrated into a system located on-board an aircraft comprising at least one sensor of the same type as the sensor used for training. The on-board system 500 also comprises: a terrain database (BDT) 502; a database (BDEI) 504 of elements of interest; a module (SVS) 506 for generating in 3D a synthetic forward-looking view from the position and the attitude of the aircraft as determined by sensors 508; sensors 510; an analyzing module 512 comprising at least one validated AI model; and a display device 514 for displaying the SVS view to the aircrew of the aircraft. The display device 514, or human-machine interface, may be a head-down display (HDD), a see-through head-up display (HUD), a see-through head-worn display (HWD), or the windshield of the aircraft. Advantageously, the usual guidance symbology showing guidance cues of the aircraft (attitude, heading, speed, altitude, vertical speed, velocity vector, etc.) is superimposed on the synthetic 3D view. The analyzing module 512 may be configured to correct the position of the runway presented on the SVS 506.

Thus, the present description illustrates one preferred but non-limiting implementation of the invention. A number of examples were provided with a view to allowing a good comprehension of the principles of the invention and a concrete application; however, these examples are in no way exhaustive, and anyone skilled in the art should be able to make modifications thereto and implement variants thereof while remaining faithful to said principles.

The invention may be implemented by means of hardware and/or software elements. It may be provided in the form of a computer program product, on a computer-readable medium, and comprises code instructions for executing the steps of the methods in their various embodiments.

1. A method for assisting with landing an aircraft under poor visibility conditions, the method comprising at least the steps of:
receiving during a phase of approach toward a runway data generated by a sensor, said runway and/or an approach lighting system not being visible to the pilot from the cockpit;
determining, in the received sensor data, data of interest characteristic of said runway and/or of said approach lighting system;
computing, on the basis of the data of interest, the coordinates of a target area; and
displaying, on a head-up display, a guiding symbol representative of the target area, said guiding symbol being displayed before the aircraft reaches the decision height, in order to provide the pilot with a visual cue in which to search for said runway and/or approach lighting system.

2. The method as claimed in claim 1, wherein the step of receiving sensor data consists in receiving data from a sensor located on-board the aircraft and looking forward, said sensor being chosen from the group consisting of FLIR guidance sensors, a multi-spectral camera, a LIDAR and a millimeter-wave radar.

3. The method as claimed in claim 1, wherein the step of determining data of interest consists in executing an artificial-intelligence algorithm on the received sensor data, the algorithm implementing an artificial-intelligence model trained for image processing, said model being obtained in a training phase by deep learning.

4. The method as claimed in claim 3, wherein the deep learning is based on convolutional neural networks.

5. The method as claimed in claim 1, wherein the step of computing a target area consists in determining, on the basis of the characteristics of the sensor and of the attitude of the aircraft corresponding to the sensor data, heading and elevation coordinates of the target area.

6. The method as claimed in claim 1, in addition comprising, after the step of computing a target area, a step of sending the coordinates of the target area to the head-up display.

7. The method as claimed in claim 5, wherein the coordinates of the target area correspond to two opposite corners of a rectangle framing the data of interest characteristic of said runway and/or said approach lighting system, and wherein the guiding symbol that is displayed is said framing rectangle.

8. The method as claimed in claim 1, wherein the step of head-up display consists in displaying the framing symbol on a fixed head-up display of the cockpit and/or on a head-up display worn by the pilot.

9. A device for assisting with landing an aircraft, especially under poor visibility conditions, said device comprising means for implementing the steps of the method for assisting with landing an aircraft under poor visibility conditions as claimed in claim 1.

10. The device as claimed in claim 9, wherein the data allowing the target area to be computed are generated by a first sensor, the device in addition comprising a second sensor able to deliver an image displayable on the head-up device worn by the pilot, the guiding symbol computed on the basis of the data of the first sensor being displayed in said image delivered by the second sensor.

11. A human-machine interface comprising means for displaying a guiding symbol obtained using the method of claim 1.

12. A system for assisting with landing, especially of SVS, SGVS, EVS, EFVS or CVS type, comprising a device for assisting with landing an aircraft, especially under poor visibility conditions, as claimed in claim 9.

13. An aircraft comprising a device for assisting with landing, especially under poor visibility conditions, as claimed in claim 9.

14. A computer program comprising code instructions for executing the steps of the method for assisting with landing an aircraft, especially under poor visibility conditions, as claimed in claim 1, when said program is executed by a processor.
